(19) United States
(12) Patent Application Publication
(10) Pub. No.: US 2006/0165202 A1
(43) Pub. Date: Jul. 27, 2006

(54) Signal processor for robust pattern recognition

(76) Inventors: Trevor Thomas, Milton (GB); Beng Tiong Tan, Eastleigh (GB)

Correspondence Address: JOHN BRUCKNER, P.C., 5708 BACK BAY LANE, AUSTIN, TX, 78739, US

(21) Appl. No.: 11/314,958

(22) Filed: Dec. 21, 2005

(30) Foreign Application Priority Data
Dec. 21, 2004 (GB) GB0427975.8

(51) Int. Cl. H04L 7/00

(52) U.S. Cl. 375/368

(57) ABSTRACT

A front-end processor that is robust under adverse acoustic condition is disclosed. The front-end processor includes a frequency analysis module configured to compute the short-time magnitude spectrum, a adaptive noise cancellation module to remove any additive noise, a linear discriminant module to reduce the dimension of feature vectors and to increase the class separability, a trajectory analysis module to capture the temporal variation of the signal, and a multi-resolution short-time mean normalisation module to reduce the long-term and short-term variations due to the differences in the channels and speakers.

### CROSS-REFERENCE TO RELATED APPLICATION

This application is related to, and claims a benefit of priority under one or more of 35 U.S.C. 119(a)-119(d) from copending foreign patent application 0427975.8, filed in the United Kingdom on Dec. 21, 2004 under the Paris Convention, the entire contents of which are hereby expressly incorporated herein by reference for all purposes.

### BACKGROUND INFORMATION

1. Field of the Invention

The present invention relates to a signal processing method and apparatus, and in particular such a method and apparatus for use with a pattern recogniser. In addition the present invention also relates to a noise cancellation method and system.

2. Discussion of the Related Art

Pattern recognisers for recognising patterns such as speech or the like are known already in the art. The general architecture of a known recogniser is illustrated in FIG. 1, which is particularly adapted for speech recognition. Here, an automatic speech recogniser 8 includes a front-end processor 2 and a pattern matcher 4 that takes a speech signal 1 as input and produces a recognised speech output 5.

A front-end processor 2 takes speech signal 1 as input and produces a sequence of observation vectors 3 representing the relevant acoustic events that capture a significant amount of the linguistic content in the speech signal 1. In addition, the observation vectors 3 produced by the front-end processor 2 preferably suppress the linguistically irrelevant events such as speaker-related features (e.g. gender, age, and accent) and the acoustic-environment related features (e.g. channel distortion and background noise).

Acoustic models 6 are provided to estimate the probabilities of the observation vectors corresponding to particular word or sub-word units such as phonemes. The acoustic models 6 characterise the sequence of observation vectors of a pattern by the HMM (hidden Markov model) approach. The HMM method describes a sequence of observation vectors in terms of a set of states, a set of transition probabilities between the states and the probability distributions of generating the observation vectors in each state. HMMs are described in more detail in Cox, S J, “Hidden Markov models for automatic speech recognition: theory and application” British Telecom Technology Journal, 6, No. 2, 1988, pp. 105-115.

A set of word models 11 is created either by using the word HMMs 6 or by concatenating each of the sub-word HMMs 6 as specified in a word lexicon 10. Language models 7 describe the allowable sequences of words or sentences. The language models 7 can be expressed as a finite state grammar or a statistical language model.

The pattern matcher 4 combines the word probabilities received from the word models 11 and the information provided by the language model 7 to decide the most probable sequence of words that corresponds to the recognised sentence 5. The pattern matcher 4 performs a Viterbi search, which finds the single best state sequence, based on dynamic programming techniques.

The performance of such a speech recogniser is dependent upon many factors, and the individual performance of its constituent elements. Of these parts, the front-end signal processing module is of importance for the reason that without observation vectors which accurately model the input speech signal the pattern matching components will not be able to function correctly. In this respect, the front-end signal processing can be susceptible to changes in background noise, long-term and short-term distortion, channel variations, and speaker variations. The present invention therefore aims to provide a further signal processing arrangement that is capable of handling at least some of the above-mentioned variable factors.

### SUMMARY OF THE INVENTION

From a first aspect the present invention provides a signal processing method for use with a pattern recogniser, comprising the steps of:—receiving an input signal to be recognised; for successive respective portions of the input signal, generating a feature vector having a plurality of characteristic coefficients representative of the signal portion; for any particular ith signal portion, calculating k sets (k>0) of dynamic coefficients in dependence on the characteristic coefficients for the ith portion and the characteristic coefficients of signal portions temporally adjacent to the ith portion, said dynamic coefficients being representative of the temporal variation of the characteristic coefficients; and outputting at least part of the k sets of dynamic coefficients to the pattern recogniser.

Within the first aspect temporal variations in characteristic coefficients can be captured, which are useful in a subsequent pattern recognition process.

From a second aspect, the present invention further provides a signal processing method for use with a pattern recogniser, comprising the steps of: receiving an input signal to be recognised; for successive respective portions of the input signal, generating a feature vector having a plurality of characteristic coefficients representative of the signal portion; for any particular ith signal portion: calculating the mean of each characteristic coefficient in dependence on corresponding coefficients from temporally adjacent signal portions; and normalising the values of the characteristic coefficients in dependence on the calculated mean values; the method further comprising outputting the normalised characteristic coefficients to the pattern recogniser. Within the second aspect variations in a communications channel over which the signal has been transmitted can be taken into account, as well as variations in the production of the signal, for example by a speaker when the signal is a speech signal. The provision of such normalised characteristic coefficients to a pattern recogniser is advantageous.

From a third aspect, the invention also provides a signal processing method for use with a pattern recogniser, comprising the steps of: receiving an input signal to be recognised; for successive respective portions of the input signal, generating a feature vector having a plurality of characteristic coefficients representative of the signal portion; for any particular ith signal portion, calculating k sets (k>0) of dynamic coefficients in dependence on the characteristic coefficients for the ith portion and the characteristic coefficients of signal portions temporally adjacent to the ith portion, said dynamic coefficients being representative of the temporal variation of the characteristic coefficients; for any particular ith signal portion: calculating the mean of each characteristic coefficient in dependence on corresponding coefficients from temporally adjacent signal portions; and normalising the values of the characteristic coefficients in dependence on the calculated mean values; the method further comprising outputting the normalised characteristic coefficients and at least part of the k sets of dynamic coefficients to the pattern recogniser.

From a fourth aspect the invention also provides a noise cancellation method for removing noise from a signal, comprising the steps of: receiving a signal to be processed; estimating a noise spectrum from the signal, said estimating including deriving a plurality of noise parameter values; and cancelling the estimated noise spectrum from a spectrum of the signal in dependence on the values of the plurality of noise parameters.

Further features and aspects will be apparent from the appended claims.

### BRIEF DESCRIPTION OF THE DRAWINGS

An embodiment of the present invention will now be described, presented by way of example only, and with reference to the accompanying drawings, wherein like reference numerals refer to like parts, and wherein:—

FIG. 1 is a block diagram of the general system architecture of a speech recogniser;

FIG. 2 is a block diagram of the elements of a signal processor in accordance with an embodiment of the invention, and illustrating the signal floes therebetween;

FIG. 3 is a diagram illustrating the overlapping of windowed signal segments to produce a frame used as a processing unit in embodiments of the invention;

FIG. 4 is a block diagram of the adaptive noise cancellation module provided by embodiments of the invention; and

FIG. 5 is an illustration of a computer system provided with computer programs on a storage medium which provides a further embodiment of the invention.

### DESCRIPTION OF PREFERRED EMBODIMENTS

An embodiment of the invention will now be described.

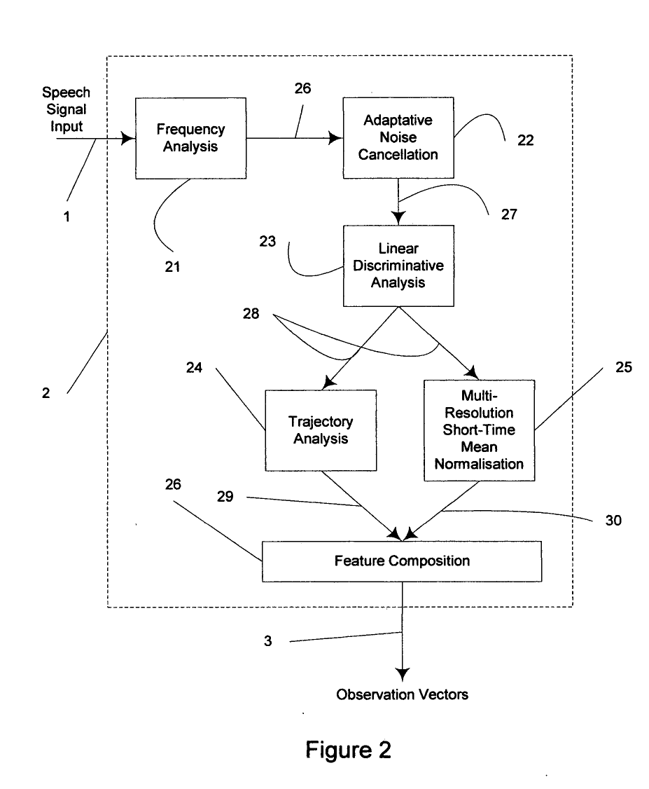

Referring to FIG. 2, a signal processor 2 for use as the front-end processor of a pattern recogniser such as a speech recogniser includes a frequency analysis module 21 to characterise the spectral content of the input speech, an adaptive noise cancellation module 22 to remove any additive noise, a linear discriminant analysis module 23 to reduce dimensionality and increase class separability, a trajectory analysis module 24 to capture the temporal variation of the signal, and a multi-resolution short-time mean normalisation module 25 to reduce the channel and speaker variations.

The adaptive noise cancellation module 22 reduces the sensitivity of the speech recogniser 2 to background noise. The adaptive noise cancellation module 22 estimates the parameters needed for a noise cancellation algorithm on an utterance by utterance basis. As will become apparent, no manual tuning is required to find the optimal parameters for use within the adaptive noise cancellation module 22.

The linear discriminant analysis module 23 reduces the dimension of the magnitude spectrum vectors and increases the class separability. The trajectory analysis module 24 characterises the temporal variations in the signal by analysing the frequency components of the features 28 in time. The multi-resolution short-time mean normalisation module 25 reduces the sensitivity of the speech recogniser 2 to channel and speaker variations. The multi-resolution short-time mean normalisation module 25 further removes both long-term and short-term variations due to the difference in the channels and speakers.

The combination of these features improves the robustness of the speech recogniser 2, especially in the presence of background noise, long-term and short-term distortion, channel variations, and speaker variations.

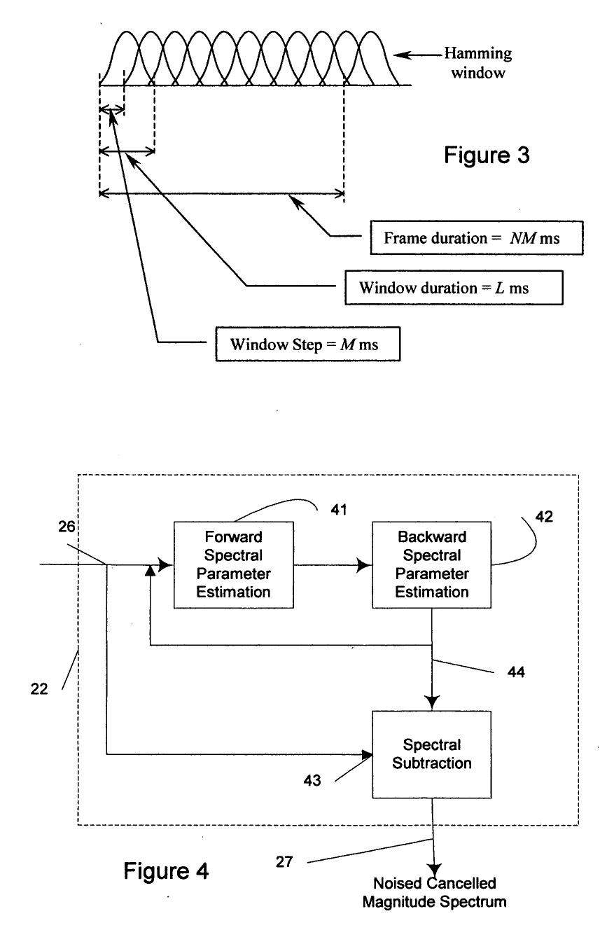

In more detail, and referring to FIG. 3 the frequency analysis module 21 blocks an input speech signal 1 into L ms segments. A typical range of L is between 7 to 9 ms. The start of consecutive segments are spaced M ms apart, such that consecutive segments overlap by L-M seconds. A typical range of M is between 1 to 2 ms. Each speech segment is multiplied by a Hamming window, and then a magnitude spectrum for each windowed speech segment is computed with a Fast Fourier Transform (FFT). A frame is then composed from N consecutive windowed speech segments. A typical range of N is between 8 to 12, such that frames are typically of M×N ms in length (typically 8 to 12 ms). A magnitude spectrum for each frame 26 is then found, being the average of the magnitude spectrum for the N windowed speech segments in the frame. The relationship between windowed speech segments and a frame is shown in FIG. 3. The frequency analysis module 21 generates a time sequence 26 of short-time magnitude spectra, being the magnitude spectra found for each successive frame. The time sequence 26 of short-time magnitude spectra is output from the frequency analysis module 21 to the adaptive noise cancellation module 22.

The adaptive noise cancellation module 22 receives the time sequence 26 of short-time magnitude spectra and operates to remove any additive noise. The adaptive noise cancellation module 22 produces a time sequence 27 of short-time noise cancelled magnitude spectra.

More particularly, referring to FIG. 4 the noise cancellation module 22 operates on an entire utterance identified in advance by a suitable end-pointing algorithm. End-pointing algorithms are known per se in the art, and operate to identify speech utterances within input signals using measures such as signal energy, zero-crossing count and the like. Within the adaptive noise cancellation module 22, the time sequence 26 of short-time magnitude spectra is buffered for an entire utterance as identified in advance by an end-pointing algorithm. Note that the end-pointing algorithm may operate prior to the frequency analysis module to identify portions of input signals to be processed, such that only those portions of input signals to be processed are input to the frequency anaylsis module. In such a case, given that the speech/non-speech segmentation is performed by the end-pointer prior to input to the front end processor, the adaptive noise cancellation module need just process each set of short time magnitude spectra output from the frequency analysis module as a single utterance.

As shown in FIG. 4, the adaptive noise cancellation module comprises a forward spectral parameter estimation module 41, and a backward spectral parameter estimation module 42. The forward parameter estimation module 41 estimates parameters for subsequent use in noise cancellation from the first frame of the utterance to the last frame of the utterance. The noise cancellation parameters are updated after the operation of the forward parameter estimation module 41. Forward parameter estimation is then followed by backward parameter estimation, by the backward parameter estimation module 42 to estimate the noise cancellation parameters algorithm from the last frame of the utterance to the first frame of the utterance. The noise cancellation parameters are updated after the backward parameter estimation. This process can be repeated several times until the parameters are converged. In practice, this process only needs to be repeated for 2 to 4 times. The parameter estimation modules 41 and 42 estimate four parameters, namely: averaged noise magnitude spectrum N, learning factor χ, overestimation factor α, and spectral flooring factor β.

The operating process of the adaptive noise cancellation module starts by receiving and storing the short-time magnitude spectra 26 for each frame of an utterance to be processed. Then, the input spectra are examined to find a frame iₘᵢₙ from the time-sequence of short-time magnitude spectra 26 such that the energy for the iₘᵢₙth frame is minimum and the energy for the iₘᵢₙth frame is greater than a threshold. In this respect, the energy of a frame is the sum of the magnitude-squared values of the digital signals in time, and hence the threshold may take a value such as 5. A noise magnitude spectrum N is then initialised by the magnitude spectrum for the iₘᵢₙth frame, the overestimation factor α is initialised to be 0.375 and the spectral flooring factor β is initialised to be 0.1. Processing of the input utterance by the forward and backward spectral parameter estimation modules 41 and 42 then commences.

More particularly, the forward spectral parameter estimation module 41 commences processing the input magnitude spectra 26 in time sequence order from the first frame to the last frame of the sequence. If the magnitude spectrum X for the current frame being processed is less than or equal to the noise magnitude spectrum N multiplied by (α+β), the noise spectrum is updated using a weighted average method. Such a method is based on a first order recursion to estimate the level of noise. In summary, the noise spectrum N is updated as follows:

$${N}^{′} = \{ \begin{matrix}χ N + ( 1 - χ ) X , & if X \leq ( α + β ) N \\ N , & otherwise\end{matrix} \qquad 1 )$$

where the learning factor χ is set to 0.99, N′ is the updated averaged noise magnitude spectrum.

For each frame processed, estimations of the overestimation factor α and the spectral flooring factor β dependent on the signal-to-noise ratio (SNR) are re-computed. A simple approach is adopted to estimate the signal-to-noise ratio. The energy of a noisy speech signal is estimated as follows:

$${E}_{x} = \{ \begin{matrix}( {n}_{x} {E}_{x} + {E}_{i} ) / ( {n}_{x} + 1 ) & {E}_{i} > 2 {E}_{n} \\ {E}_{x} & otherwise\end{matrix} \qquad 2 )$$

where Eᵢ is the energy for the current frame and Eₙ is the estimated energy of the background noise, Eₓ is the estimated energy of the noisy speech signal, and nₓ is the total number of speech frames so far. The energy of the background noise Eₙ is computed from the averaged noise magnitude spectrum N. If the energy of current frame Eᵢ is greater than the energy of background noise Eₙ multiplied by two, a speech frame is detected and the energy of noisy speech signal is updated. The signal-to-noise ratio (SNR) is the ratio between the energy of the clean speech signal and the energy of the background noise. The energy of the clean speech signal is obtained by subtracting the energy of the background noise Eₙ from the energy of the noisy speech signal Eₓ. Therefore, the signal-to-noise ratio is computed as follows:

$$SNR = \{ \begin{matrix}100 , & {E}_{n} < {10}^{- 100} \\ - 100 , & {E}_{x} < {10}^{- 100} \\ 20 {log}_{10} ( \frac{{E}_{x} - {E}_{n}}{{E}_{n}} ) , & otherwise\end{matrix} \qquad 3 )$$

The learning factor χ, overestimation factor α, and spectral flooring factor β are then adapted as a linear function of the signal-to-noise ratio, such as:
α=−0.0533×SNR+1.9667
β=0.0171×SNR+0.1
χ=−0.002×SNR+1.04 4)

The learning factor χ is limited to the range between 0.95 and 0.999, the overestimation factor α is limited to the range between 0.1 and 1, and the spectral flooring factor β is limited to the range between 0.1 and 0.7. Such re-estimations of these parameters is performed for each frame being processed of the utterance.

Once the forward spectral parameter estimation module 41 has processed the utterance from start to finish, the values for the learning factor χ, overestimation factor α, and spectral flooring factor β thus obtained are passed to the backward spectral parameter estimation module 42. Here the utterance is processed in reverse time sequence order from the last frame of the utterance to the first frame of the utterance, but with the identical processing as described above being performed for each current frame being processed. The values for the noise cancellation parameters received from the forward spectral parameter estimation 41 are used to process the first frame (last frame of the utterance timewise) to be processed, and the noise cancellation parameters then repeatedly updated and subsequently used for each frame processed from then. Once all of the frames of the utterance from the last frame to the first frame have been processed the noise cancellation parameters will have been further refined towards their convergence values.

Following operation of the backward spectral parameter estimation module 42, the present values of the noise cancellation parameters are passed back to the forward spectral parameter estimation module 42, which re-processes the utterance from the the first (timewise) frame of the utterance to the last (timewise) frame of the utterance in sequence. For each frame that is processed the values of the noise cancellation parameters are further refined. The operation of the backward spectral parameter estimation module 42 may then be repeated, using the further refined values received from the forward spectral parameter estimation module 41. As mentioned above, such operation of both forward and then backward processing the utterance to refine the values of the noise cancellation parameters may be repeated until the parameters converge, but in practice no more than 2 to 4 repetitions should be required. The final estimated parameters 44 consist of a noise averaged magnitude spectrum N, the learning factor χ, the overestimation factor α, and the spectral flooring factor β. These parameters are passed to the spectral subtraction module 43.

The spectral subtraction module 43 again processes every frame of the utterance, and in particular subtracts the noise magnitude spectrum N from the respective magnitude spectrum for each frame. More particularly, if the magnitude spectrum for a current frame Xᵢ is greater than the noise magnitude spectrum N multiplied by a factor of (α+β), the scaled noise magnitude spectrum αN is subtract from the magnitude spectrum for the current frame Xᵢ. If the magnitude spectrum for the current frame Xᵢ is less than or equal to the noise magnitude spectrum N multiplied by a factor of (α+β), the scaled noise magnitude spectrum βN is assigned to the magnitude spectrum for the current frame Xᵢ. Specifically, for a current frame Xᵢ the magnitude spectrum for the frame is updated as follows:

$${X}_{i}^{′} = \{ \begin{matrix}{X}_{i} - α N , & if {X}_{i} > ( α + β ) N \\ β N , & otherwise .\end{matrix} \qquad 5 )$$

where X′ᵢ is the noise cancelled magnitude spectrum 27. By processing every frame of an utterance as described, the adaptive noise cancellation module 22 produces a time sequence 27 of short-time noise cancelled magnitude spectra. This time-sequence 27 of noise-cancelled spectra is then output to the linear discriminative analysis module 23.

The linear discriminant analysis module 23 operates on each noise cancelled magnitude spectrum of the time-sequence 27. In particular, for any particular frame being processed, the noise cancelled magnitude spectrum for that frame is scaled and floored before taking a logarithm as follows:
Y=log(max(X_{floor},X)*a)*b 6)
where X is the noise cancelled magnitude spectrum for a frame, Y is the magnitude spectrum X in the logarithm domain, the scale factor a is set to the range between 0.9 to 1.1 and the scale factor b is set to the range between 20 to 25. The floor value X_{floor} is set to be the energy of a silence spectrum Eₛᵢₗ multiplied by 0.3. The energy of the silence spectrum Eₛᵢₗ is first initialised to be the energy for the first frame. If the energy for the current frame E is less than the energy of the silence spectrum Eₛᵢₗ multiplied by 2, the energy for the silence spectrum Eₛᵢₗ is updated by a weighted average method as follow:
E′ₛᵢₗ=0.98Eₛᵢₗ+0.02E. 7)
where Eₛᵢₗ is the energy of the silence spectrum, E is the energy for the current frame, and E′ₛᵢₗ is the updated energy of the silence spectrum. The log magnitude spectrum Y is normalised by subtracting the energy of the log magnitude spectrum Y from the log magnitude spectrum Y. The normalised log magnitude spectrum is floored at a value of −40, in that no vector may have a lesser value.

The normalised log magnitude spectrum vectors are next converted to new feature vectors of a lower dimensionality through linear discriminant analysis (LDA) such that the phoneme separability is optimised. Suppose the dimension of the normalised log magnitude spectrum vector Yₙₒᵣₘ is N, a transformation matrix P can be found to reduce the dimension down to M as follows:
C^{T}=Yₙₒᵣₘ^{T}P. 8)
where the superscript T denotes the transpose of the vector, the dimension of the vector C is M, the dimension of the matrix P is N×M, and M is smaller than N.

Principal component analysis is first applied to generate an initial transformation matrix P so that the features are decorrelated. An approximation of the principal component analysis is the inverse cosine transform commonly used with the cepstral transform. A stepwise linear discriminant analysis is then applied to refine the linear transformation matrix P by separating the feature space according to a set of classes such as phonetic classes. A gradient descent algorithm is then used to minimise the distance between the transformed feature vector C and the class it belongs to and to maximise the distance between this transformed feature vector C and all other classes. The result is that for each frame the linear discriminant analysis module 23 generates a feature vector C of M short-time discriminant coefficients. Each frame preferably consists of 12 discriminant coefficients i.e. M=12. By producing such a feature vector C for each frame, a time sequence 28 of feature vectors is produced, each containing M short-time discriminant coefficients.

The time sequence 28 of feature vectors is input to both the trajectory analysis module 24, and the multi-resolution short time mean normalisation module 25.

The trajectory analysis module 24 captures the temporal variation of the time sequence 28 of short-time discriminant coefficients. In particular, within the trajectory analysis module the cosine transform is used to capture the trajectories of the time sequence 28 of short-time discriminant coefficients to produce a time sequence 29 of dynamic coefficients. The kth order dynamic coefficients are defined as the kth component of the cosine transform. Therefore, the qth coefficient of the kth order dynamic feature for the ith frame is defined as:

$${{c}^{⋒}}_{i , k} ( q ) = {\sum }_{j = - J}^{J} {c}_{i + j} ( q ) cos ( \frac{k π ( j + J )}{2 J} ) , 0 < k < 4. \qquad 9 )$$

where the value of J is set to the range between 2 to 5, and cᵢ₊ⱼ(q) is the qth discriminant coefficient for the (i+j)th frame of the time sequence 28 of short-time discriminant coefficients. A smoothed trajectory of the short-time discrminant coefficients can be obtained by retaining only the lower order coefficients of the dynamic features. The higher orders are less related to the change in speech events. The trajectory analysis thus produces a first order, a second order, and a third order trajectory coefficient for each short-time discriminant coefficient in a frame. Thus, where there are M coefficients in any particular frame's feature vector C, then 3M dynamic coefficients will be produced. As the trajectory analysis module 24 operates on each feature vector C in turn, a time sequence 29 of short-time dynamic coefficients is produced. This time sequence 29 is output to the feature composition module 26.

As mentioned, in addition to being output to the trajectory analysis module 24, the time sequence 28 of feature vectors C is also output to the multi resolution short time mean normalisation module 25. The multi-resolution short-time mean normalisation module 25 can reduce the channel and speaker variations by computing computing both long term and short term mean values for each discriminant coefficient in a frame's feature vector. In addition both long-term and short-term normalisations are applied to remove the long-term and short-term variations, by subtracting the respective long-term and short-term mean values obtained. More specifically, the mean of the qth discriminant coefficient for the ith frame of the time sequence 28 of short-time discriminant coefficients is computed by taking the average of the qth discriminant coefficients from the (i−P)th frame to the (i+P)th frame of the time sequence of short-time discriminant coefficients 28. More particularly, the mean of the qth discriminant coefficient for the ith frame of the time sequence of short-time discriminant coefficients is given as follows:

$${\overline{c}}_{i , p} ( q ) = \frac{1}{2 P + 1} {\sum }_{j = - P}^{P} {c}_{j} ( q ) . \qquad 10 )$$

where cⱼ(q) is the qth discriminant coefficients for the jth frame of the time sequence 28 of short-time discriminant coefficients. By selecting suitable ranges for P, then either a log-term or short-term mean value may be obtained. For example, a long-term mean \overline{c}_{i,long}(q) is computed as follows:

$${\overline{c}}_{i , long} ( q ) = \frac{1}{2 {P}_{long} + 1} {\sum }_{j = - {P}_{long}}^{{P}_{long}} {c}_{j} ( q ) . \qquad 11 )$$

where the value of P_{long} is set to the range between 20 to 28.

In contrast, a short-term mean \overline{c}_{i,short}(q) is computed as follows:

$${\overline{c}}_{i , short} ( q ) = \frac{1}{2 {P}_{short} + 1} {\sum }_{j = - {P}_{long}}^{{P}_{long}} {c}_{j} ( q ) . \qquad 12 )$$

where the value of Pₛₕₒᵣₜ is set to the range between 5 to 11.

Once mean values have been found for a discriminant coefficient, the coefficient may then be normalised by subtracting the short-time mean or the long-term mean value as appropriate from the discriminant coefficient. The long-term mean normalisation is obtained by subtracting the long-term mean from the discriminant coefficient 28. Generally, the qth long-term normalised coefficient for the ith frame of the time sequence 28 of short-time discriminant coefficients is defined as follows:
\tilde{c}_{i,long}(q)=cᵢ(q)−\overline{c}_{i,long}(q) 13)
Likewise, a short-term mean normalised coefficient is obtained by subtracting the short-term mean from the discriminant coefficient. Generally, the qth short-term normalised coefficient for the ith frame of the time sequence 28 of short-time discriminant coefficients is defined as follows:
\tilde{c}_{i,short}(q)=cᵢ(q)−\overline{c}_{i,short}(q) 14)
The multi-resolution short-time mean normalisation module 25 therefore produces a time sequence 30 of feature vectors of short-time normalised coefficients. A feature vector of M short-term normalised coefficients and M long-term normalised coefficients represents each frame. As mentioned, M is preferably 12. the time sequence of feature vectors is output to the feature composition module 26.

The feature composition 26 combines the feature vectors 29 produced by the trajectory analysis module 24 and the feature vectors 30 produced by the multi-resolution short-time mean normalisation module 25 to generate a sequence 3 of observation vectors, being one observation vector for each frame. The observation vectors each consist of M long-term normalised coefficients and M short-term normalised coefficients from the feature vector corresponding to frame i of the sequence 30 (from the multi resolution short time mean normalisation module 25), and the first M coefficients of the first-order, the first M coefficients of the second-order, and the first S coefficients of the third-order from the feature vector corresponding to frame I of the sequence 29 (from the trajectory analysis module 24). S is less than M; when M is preferably 12, S is preferably 4. The observation vector 30 for the ith frame is thus preferably defined as:
oᵢ=[\tilde{c}_{i,long}(0),.\tilde{c}_{i,long}(11),\tilde{c}_{i,short}(0),.\tilde{c}_{i,short}(11),ĉ_{i,1}(0),.ĉ_{i,1}(11),ĉ_{i,2}(0),.ĉ_{i,2}(11),ĉ_{i,3}(0),.ĉ_{i,3}(3)]^{T}l 15)

The feature composition module 26 therefore produces a time sequence 30 of observation vectors, one for each frame of the utterance. Each observation vector preferably has a dimension of 52, when M is 12.

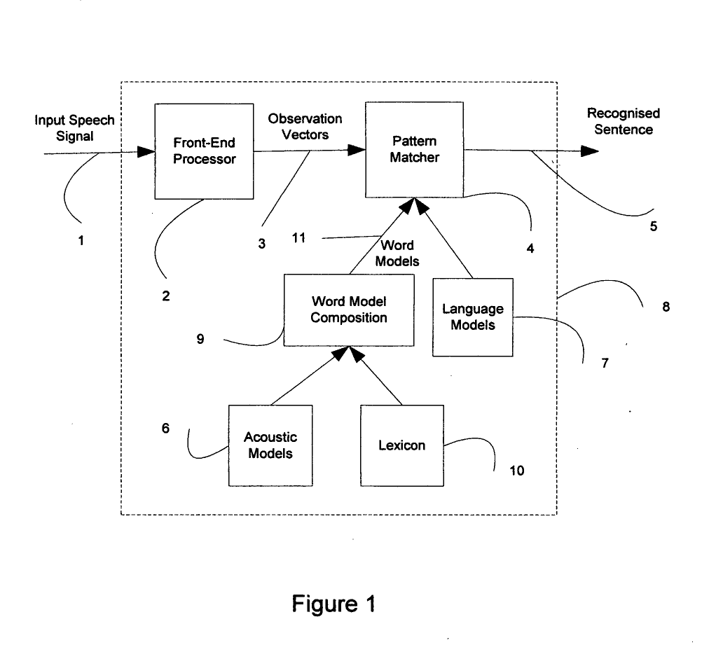

As shown in FIG. 1, when the signal processor 2 is being used as part of a pattern matcher such as a speech recogniser, the observation vectors are output to the pattern matching module 4 for comparison against appropriate predefined pattern models.

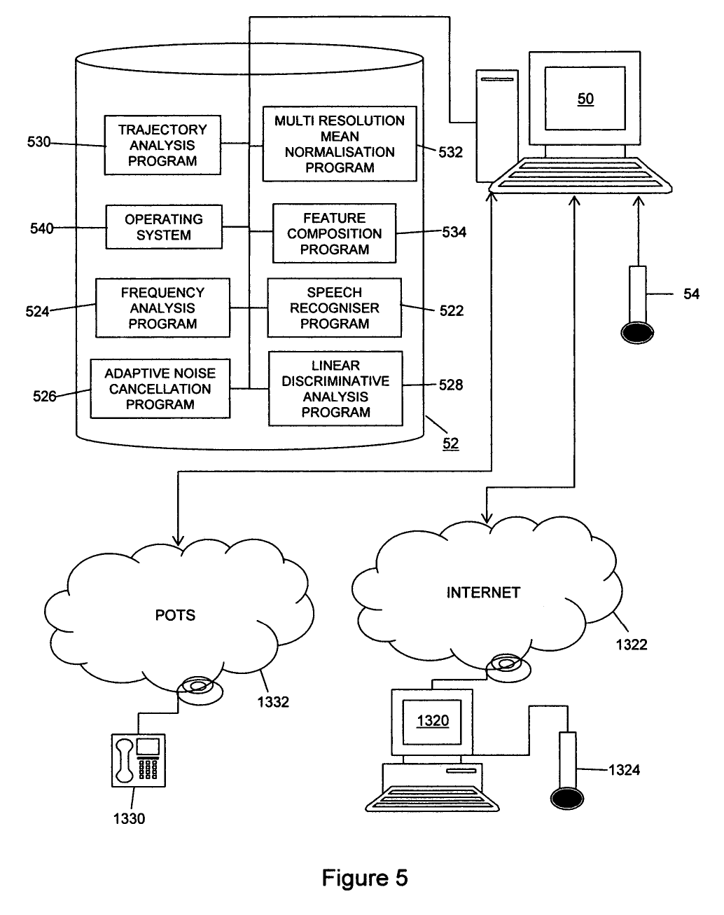

The signal processing module described above may be implemented in dedicated hardware or alternatively in software. For example, it may be implemented by a dedicated DSP chip suitably programmed, or by a general purpose computer system provided with suitable software programs to control the computer to perform the processing described. Such a general purpose computer system is shown in FIG. 5. Here, a general purpose computer system 50 is provided, which is of a conventional architecture, being provided with a central processing unit, data bus, memory, an operating system program 540, and long-term non-volatile data storage such as a hard disk drive 52 or the like. Other storage media may also be used, such as CD or DVD based storage, or solid state storage. The computer system 50 is provided with input and output devices such as a keyboard and monitor, and where the system is being used for pattern recognition, an input transducer suitable for the input signal is also provided. For speech recognition, this may be a microphone 54, or the system may be provided with a modem to receive voice signals from a telephone handset 1330 over the plain old telephone system (POTS) 1332, or via voice over IP (VoIP) logical connections over the internet 1322 to another computer system 1320 provided with a suitable input transducer such as a microphone 1324.

Stored on the storage medium 52 are computer programs which when executed by the computer system control the computer to perform set tasks. For example, in this embodiment s speech recogniser program 522 is provided, which is arranged to control the computer system 50 to perform the functions of a speech recogniser discussed previously with respect to FIG. 1, apart from those of the front-end signal processing module 2. The functions of the front end processor 2 are performed by respective frequency analysis program 524, adaptive noise cancellation program 526, linear discriminative analysis program 528, trajectory analysis program 530, multi resolution mean normalisation program 532, and feature composition program 534. These programs are each arranged such that when executed they cause the computer to perform the processing tasks of the frequency analysis module 21, the adaptive noise cancellation module 22, the linear discriminative analysis module 23, the trajectory analysis module 24, the multi resolution mean normalisation module 25, and the feature composition module 26 respectively, the respective processing operations of each being as described previously. The observation vectors thus produced by the feature composition program 534 are passed to the speech recognition program 522 for subsequent speech recognition processing.

Various modifications may be made to the above-described embodiment to provide further embodiments that are encompassed by the appended claims. Moreover, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A signal processing method for use with a pattern recogniser, comprising the steps of:—
receiving an input signal to be recognised;
for successive respective portions of the input signal, generating a feature vector having a plurality of characteristic coefficients representative of the signal portion;
for any particular ith signal portion, calculating k sets (k>0) of dynamic coefficients in dependence on the characteristic coefficients for the ith portion and the characteristic coefficients of signal portions temporally adjacent to the ith portion, said dynamic coefficients being representative of the temporal variation of the characteristic coefficients; and
outputting at least part of the k sets of dynamic coefficients to the pattern recogniser.

2. A method according to claim 1, wherein the calculating step utilises a cosine transform to determine the dynamic coefficients.

3. A method according to claim 2, wherein the dynamic coefficients are calculated in accordance with:—
$${{c}^{⋒}}_{i , k} ( q ) = {\sum }_{j = - J}^{J} {c}_{i + j} ( q ) cos ( \frac{k π ( j + J )}{2 J} ) , 0 < k < 4$$
wherein cᵢ₊ⱼ(q) is the qth discriminant coefficient for the (i+j)th frame, and wherein the characteristic coefficients of J temporally adjacent signal portions are used in the calculating step, wherein 2<=J<=5.

4. A method according to claim 1, wherein the generating step comprises:—
determining an average magnitude spectrum having N dimensions for a present signal portion; and
transforming the N dimensional magnitude spectrum into an M dimensional feature vector comprising M discriminant feature coefficients, the transforming comprising applying a transformation function adapted to maximise distances in a feature space of features of the signal to be subsequently recognised, and wherein M>N;
wherein the discriminant coefficients are used as the characteristic coefficients.

5. A method according to claim 1, wherein the generating step further comprises the step of cancelling additive noise in the characteristic coefficients.

6. A signal processing method for use with a pattern recogniser, comprising the steps of:—
receiving an input signal to be recognised;
for successive respective portions of the input signal, generating a feature vector having a plurality of characteristic coefficients representative of the signal portion;
for any particular ith signal portion:
calculating the mean of each characteristic coefficient in dependence on corresponding coefficients from temporally adjacent signal portions; and
normalising the values of the characteristic coefficients in dependence on the calculated mean values;
the method further comprising outputting the normalised characteristic coefficients to the pattern recogniser.

7. A method according to claim 6, wherein the mean values are calculated over P_{long} temporally adjacent frames, wherein P_{long} is chosen to produce long-term mean values.

8. A method according to claim 6, wherein the mean values are calculated over Pₛₕₒᵣₜ temporally adjacent frames, wherein Pₛₕₒᵣₜ is chosen to produce short-term mean values.

9. A method according to claim 6, wherein the mean values are calculated using:—
$${\overline{c}}_{i , p} ( q ) = \frac{1}{2 P + 1} {\sum }_{j = - P}^{P} {c}_{j} ( q )$$
wherein P is the number of temporally adjacent frames over which the mean values are calculated, and where cⱼ(q) is the qth discriminant coefficient for the jth frame of the time sequence.

10. A method according to claim 6, wherein both long term and short term normalised coefficients are calculated, and output to the pattern recogniser.

11. A noise cancellation method for removing noise from a signal, comprising the steps of:—
receiving a signal to be processed;
estimating a noise spectrum from the signal, said estimating including deriving a plurality of noise parameter values; and
cancelling the estimated noise spectrum from a spectrum of the signal in dependence on the values of the plurality of noise parameters.

12. A method according to claim 11, wherein the signal is received and stored prior to the estimating and cancelling steps, and wherein the estimating step further comprises processing the stored signal sequentially forwards in time and sequentially backwards in time a portion at a time, the noise spectrum and the noise parameters being updated for each portion processed.

13. A method according to claim 12, wherein the noise spectrum is updated as a function of the magnitude spectrum for the current signal portion and a first one of the noise parameters when the magnitude spectrum of the current signal portion is less than a sum of the products of the noise spectrum and a second and third noise parameter.

14. A method according to claim 12, wherein the stored signal is processed sequentially forwards and backwards repeatedly until the noise parameters are converged.

15. A method according to claim 11, wherein the cancelling step comprises subtracting the estimated noise spectrum from a respective magnitude spectrum obtained for each portion of the signal, and wherein the subtracting step further comprises determining if a respective magnitude spectrum is larger than a product of the estimated noise spectrum and a sum of a plurality of the noise parameters, and subtracting a product of the estimated spectrum and at least one of the noise parameters if so, otherwise setting the spectrum for the signal portion to equal a product of the estimated noise spectrum and an other of the noise parameters.

16. A signal processing system for use with a pattern recogniser, comprising:—
a signal input at which an input signal to be recognised is received; and
a signal processor arranged in use to:—
i) for successive respective portions of the input signal, generate a feature vector having a plurality of characteristic coefficients representative of the signal portion; and
ii) for any particular ith signal portion, calculate k sets (k>0) of dynamic coefficients in dependence on the characteristic coefficients for the ith portion and the characteristic coefficients of signal portions temporally adjacent to the ith portion, said dynamic coefficients being representative of the temporal variation of the characteristic coefficients; and
iii) output at least part of the k sets of dynamic coefficients to the pattern recogniser.

17. A system according to claim 16, wherein the calculation utilises a cosine transform to determine the dynamic coefficients.

18. A system according to claim 17, wherein the dynamic coefficients are calculated in accordance with:—
$${\overline{c}}_{i , k} ( q ) = {\sum }_{j = - J}^{J} {c}_{i + j} ( q ) cos ( \frac{k π ( j + J )}{2 J} ) , \\ 0 < k < 4$$
wherein cᵢ₊ⱼ(q) is the qth discriminant coefficient for the (i+j)th frame, and wherein the characteristic coefficients of J temporally adjacent signal portions are used in the calculating step, wherein 2<=J<=5.

19. A system according to claim 16, wherein the signal processor is further arranged in use to:—
a) determine an average magnitude spectrum having N dimensions for a present signal portion; and
b) transform the N dimensional magnitude spectrum into an M dimensional feature vector comprising M discriminant feature coefficients, the transforming comprising applying a transformation function adapted to maximise distances in a feature space of features of the signal to be subsequently recognised, and wherein M>N;
wherein the discriminant coefficients are used as the characteristic coefficients.

20. A system according to claim 16, wherein the signal processor is further arranged in use to cancel additive noise in the characteristic coefficients.

21. A signal processing system for use with a pattern recogniser, comprising:—
a signal input at which an input signal to be recognised is received; and
a signal processor arranged in use to:—
i) for successive respective portions of the input signal, generate a feature vector having a plurality of characteristic coefficients representative of the signal portion;
ii) for any particular ith signal portion:
a) calculate the mean of each characteristic coefficient in dependence on corresponding coefficients from temporally adjacent signal portions; and
b) normalise the values of the characteristic coefficients in dependence on the calculated mean values;
the signal processor being further arranged in use to:—
iii) output the normalised characteristic coefficients to the pattern recogniser.

22. A system according to claim 21, wherein the mean values are calculated over P_{long} temporally adjacent frames, wherein P_{long} is chosen to produce long-term mean values.

23. A system according to claim 21, wherein the mean values are calculated over Pₛₕₒᵣₜ temporally adjacent frames, wherein Pₛₕₒᵣₜ is chosen to produce short-term mean values.

24. A method according to claim 21, wherein the mean values are calculated using:—
$${\overline{c}}_{i , P} ( q ) = \frac{1}{2 P + 1} {\sum }_{j = - P}^{P} {c}_{j} ( q )$$
wherein P is the number of temporally adjacent frames over which the mean values are calculated and where cⱼ(q) is the qth discriminant coefficient for the jth frame of the time sequence.

25. A system according to claim 21, wherein both long term and short term normalised coefficients are calculated, and output to the pattern recogniser.

26. A noise cancellation system for removing noise from a signal, comprising:—
a signal input for receiving a signal to be processed;
a noise estimator for estimating a noise spectrum from the signal, said noise estimator being further arranged to derive a plurality of noise parameter values; and
a noise cancellor for cancelling the estimated noise spectrum from a spectrum of the signal in dependence on the values of the plurality of noise parameters.

27. A system according to claim 26, and further comprising a signal buffer arranged to receive and store the input signal; the noise estimator being further arranged to process the stored signal sequentially forwards in time and sequentially backwards in time a portion at a time, the noise spectrum and the noise parameters being updated for each portion processed.

28. A system according to claim 27, wherein the noise spectrum is updated as a function of the magnitude spectrum for the current signal portion and a first one of the noise parameters when the magnitude spectrum of the current signal portion is less than a sum of the products of the noise spectrum and a second and third noise parameter.

29. A system according to claim 27, wherein the stored signal is processed sequentially forwards and backwards repeatedly until the noise parameters are converged.

30. A system according to claim 26, wherein the noise cancellor further comprises a subtractor arranged to subtract the estimated noise spectrum from a respective magnitude spectrum obtained for each portion of the signal, and wherein the subtractor further comprises an evaluator for determining if a respective magnitude spectrum is larger than a product of the estimated noise spectrum and a sum of a plurality of the noise parameters, the subtractor being further arranged to subtract a product of the estimated spectrum and at least one of the noise parameters if the evaluator indicates that the respective magnitude spectrum is larger than the product of the estimated noise spectrum and the sum of a plurality of the noise parameters; the subtractor being further arranged to otherwise set the spectrum for the signal portion to equal a product of the estimated noise spectrum and an other of the noise parameters.
